(19) United States
(12) Patent Application Publication
(10) Pub. No.: US 2014/0265236 A1
(43) Pub. Date: Sep. 18, 2014

(54) Stand Bracket For A Bicycle

(71) Applicant: HARRIS TOOLING INTERNATIONAL PTY. LTD., Glenelg South (AU)

(72) Inventor: Shane Antony Harris, Glenelg South (AU)

(73) Assignee: HARRIS TOOLING INTERNATIONAL PTY. LTD., Glenelg South (AU)

(21) Appl. No.: 14/205,557

(22) Filed: Mar. 12, 2014

(30) Foreign Application Priority Data
Mar. 15, 2013 (AU) 2013900921

(51) Int. Cl. B62H 1/00

(52) U.S. Cl. CPC B62H 1/00
USPC 280/295; 280/293

(57) ABSTRACT

The present invention relates to a stand bracket 100 including a mounting portion 102 and a body portion 106. The mounting portion 102 is arranged so that the stand bracket 100 can be connected to a bicycle. The body portion 106 includes a connector for connecting with an item. The item and the stand bracket 100 when connected establish a stand for standing the bicycle in a generally upright position. In a preferred form, the connector is arranged to connect with a first end of a bicycle pump 150.

### CROSS REFERENCE TO RELATED APPLICATION

This application is related to Australian Provisional Patent Application No. 2013900921 filed on 15 Mar. 2013, the contents of which are incorporated herein by this reference.

### TECHNICAL FIELD

The present invention relates to a stand bracket for a bicycle.

### BACKGROUND OF INVENTION

Many bicycles are fitted with a “kick” stand. Such stands have a first end part connected to the bicycle and a leg movable between an “in use” position and a “storage” position. In the “in use” position, the free end of the leg extends generally downwardly towards the ground so that the weight of the bike can be rested on the leg. When the bike is rested on the leg, the bike is held at an angle to the vertical but still in a generally upright position. In the “storage” position of the stand, the leg typically extends generally horizontally. The leg can be moved between the “in use” and “storage” positions by “kicking” the leg of the stand so that it pivots between the two positions.

A problem with such “kick” stands is that under some conditions they may swing down to the “in use” position inadvertently, possibly causing the stand to strike the ground or another object. This can cause the rider to fall and suffer serious injury. This is a particular problem on mountain bikes where the terrain being ridden over is quite rough and undulating. Repeated jarring of the bicycle due to the rough terrain may cause the “kick” stand to move away from the “storage” position.

Another problem with such stands is that they are quite cumbersome and increase the total weight of the bicycle. Some bicycle enthusiasts want to minimise bicycle weight whilst still ensuring sufficient frame strength. Accordingly, they do not fit stands to their bike and thus will rest them against a building or the like to keep them in a generally upright position when they are not in use. This can be problematic when there are a large number of riders at one location trying to “stand” their bike. Although such riders seek to minimise bicycle weight most will still elect to carry tire repair items, including a pump. Pumps are often mounted to the frame of the bicycle or form part of the standard equipment carried by the rider.

The present invention seeks to provide a stand bracket that can be used to address or at least alleviate the aforementioned problems.

The discussion of the background to the invention herein is included to explain the context of the invention. This is not to be taken as an admission that any of the material referred to was published, known or part of the common general knowledge as at the priority date of this application.

### SUMMARY OF INVENTION

According to the present invention, there is provided a stand bracket including a mounting portion and a body portion, the mounting portion is arranged so that the stand bracket can be connected to a bicycle, the body portion including a connector for connecting with an item, whereby the item and the stand bracket when connected establish a stand for standing the bicycle in a generally upright position.

The item is preferably generally elongate.

The elongated item may adopt different forms but is preferably a bicycle pump. Other possible elongated items for connecting to the body portion may include a tool for use on a bicycle, a tyre lever, a removable component of a bicycle (for example a seat and seat post, a bark buster bar or an aero bar) and bicycle riding attire such as a helmet or mountain bike armour. It is envisaged that the elongated item may be any item typically utilised by a person riding a bicycle and that would be effective in standing a bicycle in a generally upright position when in combination with the stand bracket. The item must be “elongated” so as to be able to extend from the stand bracket to the ground a distance sufficient to stand the bicycle in the generally upright position.

The connector is preferably an aperture, opening, depression, groove or a bore arranged to receive a first part of the elongated item. Alternatively, the connector may include a threaded element arranged to threadedly engage with a corresponding threaded part of the item. For example, the item may include a female screw thread arranged to be threaded to a male screw thread of a part of the body portion of the bracket. Reciprocal arrangements are envisaged.

In accordance with a preferred form of the invention, the elongated item is a bicycle pump and the first part of the pump is a first end thereof. The first end of the pump is, in use, arranged to be received into the connector which is formed as bore. The first end of the pump is received in the bore so that the weight of the bicycle can be transferred to the ground via the stand bracket and the pump. The bicycle being held in a generally upright configuration by the stand bracket and bicycle pump in combination.

The body portion preferably includes an aperture or opening for receiving a rod. The rod is arranged to facilitate connection of a wheel of the bicycle to the frame of the bicycle.

The body portion preferably extends at an angle to the plane of a face of the mounting portion. The body portion and the mounting portion are preferably joined by at least one curved portion.

The body portion is preferably connected to the frame of the bicycle so that the stand bracket is not movable relative thereto.

The stand bracket is preferably made of a light weight, preferably high yield strength material.

### BRIEF DESCRIPTION OF DRAWINGS

Embodiments of the invention will now be described, by way of example only, with reference to the accompanying drawings in which:

FIG. 1 illustrates a bicycle being held in a generally upright position by a stand bracket according to an embodiment of the invention when connected to an elongated item in the form of a bicycle pump;

FIG. 2 illustrates a stand bracket according to an embodiment of the invention connected to a quick release rear axle skewer and showing a pump fitted in the stand bracket;

FIG. 3 is a perspective view of the stand bracket shown in FIG. 2;

FIG. 4 is a side view of the stand bracket shown in FIG. 2;

FIG. 5 is a cross sectional view of the stand bracket shown in FIG. 2; and

FIG. 6 is a front view of the stand bracket shown in FIG. 2.

### DETAILED DESCRIPTION OF THE INVENTION

FIG. 1 illustrates a bicycle 2 being held in a generally upright configuration by a stand established by the combination of a stand bracket 100 (in accordance with an embodiment of the invention) and an item in the form of a bicycle pump 150. Stand bracket 100 is shown more clearly in FIGS. 2 to 6.

Bicycle 2 is fitted with a quick release type rear wheel 5 using a quick release skewer 10. Although the following description of a preferred embodiment of the invention is made with reference to use in association with a quick release skewer 10, the invention is not so limited. Embodiments of the invention may be used in association with any type of wheel connection, including a standard axle connection where the wheel is not set up for quick release.

As shown in FIG. 2, the quick release skewer 10 includes a rod 12 which is arranged to be inserted through the hub of the bicycle wheel 5, a nut 14 arranged to be mounted on the outer threaded end of the rod 12 and a lever operated locking assembly (i.e. a cam lock) 16. Cam lock 16 together with nut 14 are arranged to secure the hub and hence the wheel 5 between the rear forks of the bicycle 2.

Stand bracket 100 includes a mounting portion 102 with aperture 104 through which the rod 12 is arranged to pass. In use, the mounting portion 102 is located between the cam lock 16 and the fork 200 (shown schematically in FIG. 2) and is held securely in the position as shown in FIG. 2.

Stand bracket 100 further includes body portion 106 which extends at an angle to the mounting portion 102 as best shown in FIG. 4. As depicted, the angle is preferably about 25 degrees. Body portion 106 includes a connector for connecting with an elongated item such as a bicycle pump 150. In accordance with the illustrated preferred embodiment of the invention, the connector includes an aperture or bore 108 formed in the body portion 106 that is shaped so as to be able to receive or engage with a first end of the bicycle pump 150. In accordance with the illustrated embodiment, the bore 108 is configured to receive the first end of a high performance pump 150 which has screw connectors to the valves. It will of course be understood that the aperture or bore 108 may adopt different configurations dependent on the configuration of the first part of the elongated item (e.g. pump) to be located therein.

Although not illustrated, other forms of connector are envisaged. For example the connector may adopt a configuration enabling a slide fit between the connector and the elongated item. The connector may, for example, be configured whereby it fits about the first end of the elongated item or may be received within the first end of the elongated item.

The bore 108 may adopt different configurations depending on the shape of the first end of the pump 150 but must be configured to avoid possible damage to any part of the first end of the pump 150. As best shown in FIG. 5, the bore 108 includes an internal step 110 that establishes an outer bore 108a and an inner bore 108b. Inner bore 108b is established to reduce the weight of the stand bracket 100. Accordingly, it will be appreciated that the volume of the inner bore 108b defines a hollow that is effective to reduce the weight of the body portion 106. The body portion 106 and/or mounting portion 102 may include further hollows to reduce the weight of the stand bracket 100.

Step 110 is provided so that the first end of the pump 150 can be pressed into the bore 108a until it engages against the step 110. For improved stability of the stand established by connecting the pump 150 to the stand bracket 100, it is preferable that the fit between the bore 108a and the first end of the pump 150 is a clearance fit which allows easy installation of the first end of the pump 150 but does not allow the pump 150 to “slop” around within the bore 108a.

The pump 150 then acts as the “leg” of the stand against which the bicycle 2 may be stood. The weight of the bicycle 2 is then transferred to the ground via the stand bracket 100 and pump 150 and the bicycle 2 is held by the combined stand bracket 100 and pump 150 in the generally upright configuration shown in FIG. 1. It will thus be appreciated that the elongate body of the pump 150 provides a part equivalent to the leg of a conventional “kick” stand when fitted into the bore 108 of the stand bracket 100.

Body portion 106 and/or the bore 108 are located at an angle to the plane of the face 102a of the mounting portion 102. Accordingly, in use of the stand bracket 100 (i.e. when the pump 150 is fitted thereto), the frame of the bicycle 2 will rest in a plane away from the vertical and at such an angle that the bicycle 2 is reasonably stable.

As best shown in FIGS. 4 and 5, the body portion 106 is joined to the mounting portion 102 by a curved portion 112. The inclusion of such a curved portion 112 increases the strength of the stand bracket 100.

An arrangement according to an embodiment of the invention is advantageous because the stand bracket (without a pump attached) is relatively short in length as compared to conventional “kick” stands. This means that there is reduced likelihood of the stand bracket striking the ground or other objects during use of the bicycle. The stand bracket is not pivoted between an “in use” and a “storage” position because it is permanently retained in the “in use” position. Further, prior art “kick” stands and the like include both a part for connection to the bicycle and some form of a pivotable leg which adds weight that must be carried, in addition to service items such a pump. Embodiments of the present invention enable weight to be minimised because a bicycle stand is established by connecting a pump (that is already normally carried on the bicycle or by the rider) to the stand bracket (which has no leg) and thus no additional weight is added due to the stand bracket needing to additionally have such a leg. The stand created by connecting the pump to the stand bracket is easy to assemble and robust.

The embodiments have been described by way of example only and modifications within the spirit and scope of the invention are envisaged.

1. A stand bracket comprising a mounting portion and a body portion, the mounting portion adapted for connection to a bicycle, the body portion including a connector for connecting with an item, the item and the body portion being connectable to form a stand for standing the bicycle in a generally upright position.

2. The stand bracket according to claim 1 wherein the item is a generally elongate item.

3. The stand bracket according to claim 2 wherein the connector includes an aperture, an opening, a depression, a groove or a bore arranged to receive a first part of the generally elongated item.

4. The stand bracket according to claim 1 wherein the connector includes an inner bore and an outer bore.

5. The stand bracket according to claim 1 wherein the body portion includes an aperture for receiving a rod arranged to enable connection of a wheel of the bicycle to a part of the bicycle.

6. The stand bracket according to claim 1 wherein the body portion extends at an angle relative to the mounting portion.

7. The stand bracket according to claim 1 wherein the body portion and the mounting portion are joined by at least one curved portion.

8. The stand bracket according to claim 1 wherein the mounting portion and body portion are made of a light weight material.

9. The stand bracket according to claim 1 wherein the mounting portion and the body portion are made of a high yield strength material.

10. The stand bracket according to claim 1 wherein the body portion and/or the mounting portion includes at least one hollow.

11. The stand bracket according to claim 1 wherein the connector is adapted to connect with an item selected from the group consisting of a bicycle pump, a tire lever, a tool for a bicycle, a removable component of a bicycle, a helmet or mountain bike armour.

12. The stand bracket according to claim 1 wherein the item is a bicycle pump.

13. A bicycle stand comprising a stand bracket according to claim 1 and wherein the item is a bicycle pump.
